(19) United States
(12) Patent Application Publication
(10) Pub. No.: US 2024/0063366 A1
(43) Pub. Date: Feb. 22, 2024

(54) PRE-LITHIATED ELECTRODES FOR LI-ION BATTERIES

(71) Applicant: Rivian IP Holdings, LLC, Plymouth, MI (US)

(72) Inventors: Karthik BHATT, San Jose, CA (US); Elil RANGASAMY, Oakland, CA (US); Tom Andrew WYNN, San Jose, CA (US)

(21) Appl. No.: 17/890,504

(22) Filed: Aug. 18, 2022

(51) Int. Cl. H01M 4/139; H01M 4/04; H01M 4/62; H01M 4/66

(52) U.S. Cl. CPC H01M 4/139; H01M 4/0435; H01M 4/0404; H01M 4/0423; H01M 4/0426; H01M 4/628; H01M 4/661; H01M 2004/027

(57) ABSTRACT

Provided are pre-lithiated electrodes, and systems and methods of making pre-lithiated electrodes. The pre-lithiated electrode can be formed from depositing an electrode layer on a lithium coated current collector to form an electrode-lithium coated current collector and calendering the electrode-lithium coated current collector to transfer lithium from the lithium coated current collector to the electrode layer to form the pre-lithiated electrode film. The pre-lithiated electrode film can have a greater concentration of lithium in a first portion of the electrode layer that is closer to the current collector than a second portion of the electrode layer that is farther from the current collector.

### INTRODUCTION

This disclosure is generally directed to pre-lithiated electrodes (e.g., cathodes, anodes) and methods of making such pre-lithiated electrodes, which can be used in lithium-ion batteries.

### BRIEF SUMMARY

In a typical lithium-ion battery manufacturing process, the lithium-ion battery suffers from high first cycle active lithium losses resulting from solid electrolyte interphase formation. This loss of lithium permanently decreases the available energy by the consumption of lithium from the cathode material. It is common to compensate for this first cycle loss utilizing the cathode. However, because cathode active materials have lower energy density and contribute most to the cost of the cell, this can be an ineffective method of compensating for the first cycle loss. Disclosed herein are methods of pre-loading the first cycle loss via lithiation of the electrode. These pre-lithiated electrodes can be significantly more efficient (e.g., greater energy density and lower cost) and can favorably affect cycle life and/or fast charging dependent on end use implementation.

In some embodiments, a method of forming a pre-lithiated electrode film includes depositing an electrode layer on a lithium coated current collector to form an electrode-lithium coated current collector; and calendering the electrode-lithium coated current collector to transfer lithium from the lithium coated current collector to the electrode layer to form the pre-lithiated electrode film. In some embodiments, a first concentration of lithium in a first portion of the electrode layer closer to the current collector is greater than a second concentration of lithium in a second portion of the electrode layer that is farther from the current collector. In some embodiments, the method includes cutting the pre-lithiated electrode film into a plurality of pre-lithiated electrodes. In some embodiments, the method includes depositing a layer comprising lithium on a current collector to form the lithium coated current collector. In some embodiments, the layer comprising lithium is deposited via thermal evaporation, e-beam evaporation, or sputtering. In some embodiments, the method includes depositing a protection or passivation layer on a surface of the layer comprising lithium opposite the current collector. In some embodiments, the protection layer passivates the surface of the layer comprising lithium. In some embodiments, the protection layer comprises lithium oxide, lithium nitride, lithium hydroxide, lithium carbonate, or a combination thereof. In some embodiments, the method includes unwinding a roll of a lithium coated current collector film, wherein the lithium coated current collector film comprises the lithium coated current collector and a substrate layer on a side of the lithium coated current collector. In some embodiments, the method includes separating the substrate layer from the lithium coated current collector prior to depositing the electrode layer on the lithium coated current collector. In some embodiments, the method includes rewinding the separated substrate layer into a roll. In some embodiments, calendering the electrode-lithium coated current collector densifies the electrode-lithium coated current collector. In some embodiments, calendering the electrode-lithium coated current collector bonds the electrode layer to the lithium coated current collector. In some embodiments, the current collector comprises a metal substrate. In some embodiments, the metal substrate is a metal foil. In some embodiments, the metal is copper or nickel. In some embodiments, the electrode layer is an anode layer.

In some embodiments, a system includes an electrode coater configured to receive a lithium coated current collector and to deposit an electrode layer on the lithium coated current collector to form an electrode-lithium coated current collector; and a calender configured to receive the electrode-lithium coated current collector and apply pressure to the electrode-lithium coated current collector to transfer lithium from the lithium coated current collector to the electrode layer to form a pre-lithiated electrode film. In some embodiments, a first concentration of lithium in a first portion of the electrode layer closer to the current collector is greater than a second concentration of lithium in a second portion of the electrode layer that is farther from the current collector. In some embodiments, the system includes a notcher configured to receive the pre-lithiated electrode film and cut the pre-lithiated electrode film into a plurality of electrodes. In some embodiments, the system includes an unwinder configured to unwind a roll of a lithium coated current collector film comprising the lithium coated current collector. In some embodiments, the lithium coated current collector film comprises a substrate layer on a side of the lithium coated current collector. In some embodiments, the substrate layer is separated from the lithium coated current collector. In some embodiments, the system includes a rewinder configured to rewind the separated substrate layer into a roll. In some embodiments, the system includes a lithium coater configured to deposit a layer comprising lithium on a current collector to form the lithium coated current collector.

In some embodiments, an electrode includes a current collector; and an electrode layer on a side of the current collector, wherein a first portion of the electrode layer closer to the current collector has a greater concentration of lithium than a second portion of the electrode layer farther from the current collector. In some embodiments, the current collector comprises a copper or nickel foil. In some embodiments, the electrode layer is an anode layer. In some embodiments, the electrode includes a second electrode layer on a side of the current collector opposite the first electrode layer, wherein a first portion of the second electrode layer closer to the current collector has a greater concentration of lithium than a second portion of the second electrode layer farther from the current collector.

The embodiments disclosed above are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g., method, can be claimed in another claim category, e.g., system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example of a typical direct contact pre-lithiation process.

FIG. 2 illustrates a pre-lithiation process in accordance with some embodiments disclosed herein.

FIG. 3 illustrates an example of a pre-lithiated electrode film in accordance with some embodiments disclosed herein.

FIG. 4 illustrates a flow chart for a typical battery cell manufacturing process in accordance with some embodiments disclosed herein.

FIG. 5 depicts an illustrative example of a cross sectional view of a cylindrical battery cell in accordance with some embodiments disclosed herein.

FIG. 6 depicts an illustrative example of a cross sectional view of a prismatic battery cell in accordance with some embodiments disclosed herein.

FIG. 7 depicts an illustrative example of a cross section view of a pouch battery cell in accordance with some embodiments disclosed herein.

FIG. 8 illustrates cylindrical battery cells being inserted into a frame to form a battery module and pack in accordance with some embodiments disclosed herein.

FIG. 9 illustrates prismatic battery cells being inserted into a frame to form a battery module and pack in accordance with some embodiments disclosed herein.

FIG. 10 illustrates pouch battery cells being inserted into a frame to form a battery module and pack in accordance with some embodiments disclosed herein.

FIG. 11 illustrates an example of a cross-sectional view of an electric vehicle that includes at least one battery pack in accordance with some embodiments disclosed herein.

In the Figures, like reference numerals refer to like components unless otherwise stated herein.

### DETAILED DESCRIPTION

In the past decade, lithium-ion manufacturing has successfully navigated the drive to increase energy density while simultaneously reducing cost. However, with every successful iteration, it becomes exponentially more difficult for the subsequent optimization. Pre-lithiation of battery electrodes can be an option that successfully enables the next iteration for cost reduction coupled with an energy density improvement.

There are four main methods of pre-lithiation of the anode material: (1) particle level pre-lithiation using reactive chemistry; (2) slurry casting and pressure activated via stabilized lithium metal powders; (3) electrochemical pre-lithiation; and (4) direct contact pre-lithiation. Although these offer multiple paths toward successful pre-lithiation, each one of them suffer from significant challenges.

Particle level pre-lithiation using reactive chemistry is typically achieved via a reducing agent (e.g., butyl methyl ether). This technique typically offers the best path due to homogeneity in lithium concentration on a particle level. However, the environmental sensitivity of the reaction and pre-lithiated products adds a significant cost burden on the raw material for anodes. In addition, processing of pre-lithiated powders during anode coating is also severely limited by compatible solvents.

Slurry casting and pressure activated via stabilized lithium metal powders (SLMPs) involves these SLMPs cast directly onto the electrode slurry. This method also includes utilizing a compatible solvent such as xylene in combination with styrene butadiene rubber binder. The SLMPs get activated during electrode calendering resulting in homogenous pre-lithiated electrodes. However, the use of xylene can make the electrode casting process environmentally limited with options required for abatement.

Electrochemical pre-lithiation is akin to a typical battery assembly process wherein a charge cycle is enabled between the fabricated anode roll and a lithium counter electrode. Utilizing electrochemistry allows precise control over dosage and the electrode potential. Thus, the impact on first cycle loss when the anodes are assembled in a battery is the highest. However, the exposure to traditional electrolytes and lithium during pre-lithiation imposes several restrictions during downstream processing and cell fabrication.

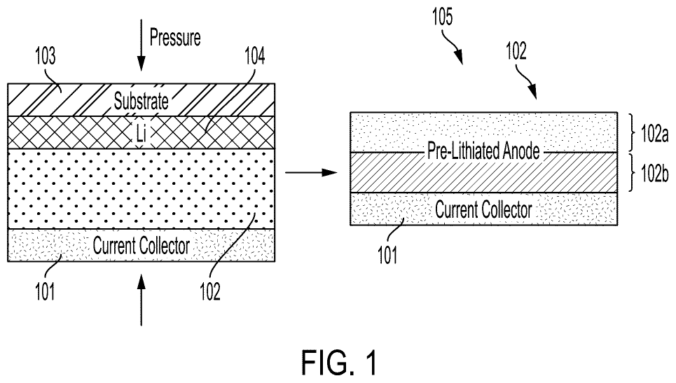

Direct contact pre-lithiation can be achieved by calendering together a lithium coated substrate with an anode foil. The pressure from the calendering can activate the pre-lithiation which can be completed over an elapsed duration. The duration can depend on the concentration of pre-lithiation required. FIG. 1 illustrates an example of a typical direct contact pre-lithiation process. As shown in FIG. 1, substrate 103 with a lithium layer 104 or a lithium containing material is brought in the vicinity of a coated electrode with an electrode layer 102 on a current collector 101. Pressure is then applied to the entire multilayer structure (via a calender) and this results in a pre-lithiated electrode that has an increased concentration of lithium at its external surface. For example, FIG. 1 shows a hypothetical pre-lithiated electrode 105 having electrode layer 102 on a side of current collector 101, wherein a first portion 102a of the electrode layer farther from the current collector has a greater concentration of lithium than a second portion 102b of the electrode layer closer to the current collector. As such, there is an increased concentration of lithium at the surface once pre-lithiation is completed. Such a concentration gradient is unfavorable to cell chemistry and can also adversely impact cell safety along with long term performance.

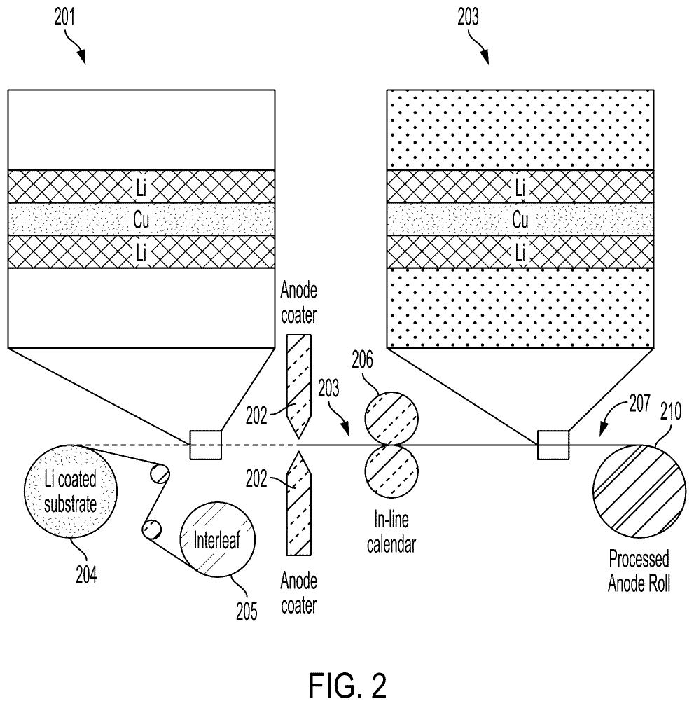

In contrast to a typical direct contact pre-lithiation process, the pre-lithiation process disclosed herein can result in an increased concentration of lithium towards the middle of the electrode rather than at the external surface. FIG. 2 illustrates an example system and process for direct contact pre-lithiation disclosed herein. As shown in FIG. 2, an electrode layer can be deposited on a lithium coated current collector 201 via an electrode coater 202. As such, the electrode coater can be configured to receive the lithium coated current collector and can deposit at least one electrode layer to form an electrode-lithium coated current collector 203. In some embodiments, an electrode layer can be deposited on at least one side of the lithium coated current collector.

In some embodiments, the lithium coated current collector can include a current collector layer and at least one lithium layer. In some embodiments, the lithium coated current collector can include a current collector layer and a lithium layer on both sides of the current collector layer. In some embodiments, the current collector can be a ribbon or foil. In some embodiments, the current collector can include a metal or metal alloy. In some embodiments, the metal can be aluminum, copper, nickel, iron, titanium, stainless steel, or combinations thereof. In some embodiments, the current collector can include a carbonaceous material. In some embodiments, the current collector can be coated with carbon. For example, the current collector may be a metal that is coated with carbon (e.g., carbon-coated aluminum foil). In some embodiments, an electrode layer can be deposited on both sides of the lithium coated current collector as shown by the electrode-lithium coated current collector 203 with lithium layer on both sides of the current collector and an electrode layer on each lithium layer opposite the current collector. As such, the electrode-lithium coated current collector can have a corresponding structure (in order) of electrode layer, lithium layer, current collector, lithium layer, and electrode layer.

In some embodiments, the at least one lithium layer on the current collector can be deposited by a lithium coater. In some embodiments, the lithium deposition can be accomplished by any one of a plurality of deposition methods such as thermal evaporation, e-beam evaporation, sputtering, etc., or a combination thereof. In some embodiments, the lithium layer on the current collector can have a thickness of about 1-30 μm, about 1-20 μm, about 1-15 μm, or about 1-10 μm. In some embodiments, the lithium layer can have a thickness of about 5-20 μm. In some embodiments, the lithium layer can be pure lithium or 100 wt. % lithium. In some embodiments, the lithium layer can be 90-99.99 wt. %, 93-99.99 wt %, or 95-99.9 wt. % lithium and contain additional cations such as Mg, Na, K, Ca, etc., up to 0.5 wt. % per additional cation or all cations. In some embodiments, a surface of the lithium layer can be nascent.

In some embodiments, at least one protective or passivation layer can be on a surface of the lithium layer opposite the current collector. In some embodiments, both lithium layers on opposite surfaces of the current collector can have at least one protective or passivation layer. In some embodiments, the protection layer can passivate the surface of the lithium layer. In some embodiments, the protective or passivation layer can be formed naturally (e.g., naturally occurring reactions) on a surface of the lithium layer. In some embodiments, a protective or passivation layer can include a naturally reactive species such as lithium oxide, lithium nitride, lithium hydroxide, lithium carbonate, derivatives thereof, or a combination thereof. In some embodiments, a protective or passivation layer can include intentionally developed layers such as lithium carbonate, lithium nitride, lithium sulfide, derivatives thereof, or a combination thereof. In some embodiments, the protective or passivation layer can be added to the lithium layer by any layer deposition method known in the art.

In some embodiments, after the lithium coated current collector is prepared it can be wound in a roll for storage. In some embodiments, the lithium coated current collector can also include at least one interleaf layer. The interleaf layer can help prevent the lithium layers from adhering to one another during storage and/or protecting the lithium layers. In some embodiments, the at least one interleaf layer can be added after the current collector is coated with the at least one lithium layer. In some embodiments, the at least one interleaf layer is added before the current collector is coated with the at least one lithium layer.

Before the lithium coated current collector is coated with an electrode layer, any interleaf layer can be removed. In some embodiments, a roll of a lithium coated current collector film can be unwound (via unwinder 204) prior to adding the at least one electrode layer to the lithium coated current collector. In some embodiments, any interleaf layer of the lithium coated current collector film can be removed or separated from the lithium coated current collector prior to deposition of an electrode layer. In some embodiments, the separated or removed interleaf layer can be rewound into a roll (via rewinder 205).

In some embodiments, an electrode layer can be deposited on at least one side of the lithium coated current collector via slot die coating, gravure coating, electrostatic spray deposition, dry roll-to-roll electrode fabrication, or combinations thereof. In some embodiments, the electrode layer can include electrode active materials, conductive carbon material, binders, and/or other additives. In some embodiments, the electrode active materials include cathode active materials and/or anode active materials. In some embodiments, the cathode active materials can include high-nickel content (greater than or equal to 80% Ni) lithium transition metal oxide like a particulate lithium nickel manganese cobalt oxide (“LiNMC”), lithium nickel cobalt aluminum oxide (“LiNCA”), lithium nickel manganese cobalt aluminum oxide (“LiNMCA”), lithium metal phosphates like lithium iron phosphate (“LFP”), Lithium iron manganese phosphate (“LMFP”), and combinations thereof. In some embodiments, the cathode active materials can include sulfur containing cathode active materials such as Lithium Sulfide (Li2S), lithium polysulfides, Titanium Disulfide (TiS2), and combinations thereof. In some embodiments, the anode active materials can include graphitic carbon (e.g., ordered or disordered carbon with sp2 hybridization, artificial or natural Graphite, or blended), Li metal anode, silicon-based anode (e.g., silicon-based carbon composite anode, silicon metal, oxide, carbide, pre-lithiated), silicon-based carbon composite anode, lithium alloys (e.g., Li—Mg, Li—Al, Li—Ag alloy), lithium titanate, or combinations thereof. In some embodiments, an anode material can be formed within a current collector material. For example, an electrode can include a current collector (e.g., a copper foil) with an in situ-formed anode (e.g., Li metal) on a surface of the current collector facing the separator or solid-state electrolyte. In such examples, the assembled cell does not comprise an anode active material in an uncharged state.

In some embodiments, the conductive carbon material can include graphite, carbon black, carbon nanotubes, Super P carbon black material, Ketj en Black, Acetylene Black, SWCNT, MWCNT, carbon nanofiber, graphene, and combinations thereof. In some embodiments, the binders can include polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”), carboxymethylcellulose (“CMC”), agar-agar, alginate, amylose, Arabic gum, carrageenan, caseine, chitosan, cyclodextrines (carbonyl-beta), ethylene propylene diene monomer (EPDM) rubber, gelatine, gellan gum, guar gum, karaya gum, cellulose (natural), pectine, poly(3,4-ethylenedioxythiophene) polystyrene sulfonate (PEDOT-PSS), polyacrylic acid (PAA), poly(methyl acrylate) (PMA), poly(vinyl alcohol) (PVA), poly(vinyl acetate) (PVAc), polyacrylonitrile (PAN), polyisoprene (Plpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or combinations thereof.

In some embodiments, an electrode layer can have an electrode active material of about 90-99.9 wt. %, about 91-99 wt. %, about 93-99 wt. %, about 94-99 wt. %, about 95-99 wt %, or about 95-97 wt. % of the electrode layer. In some embodiments, an electrode layer can have binders of about 0.1-5 wt. %, about 0.5-4 wt. % or about 1-3 wt. % of the electrode layer. In some embodiments, an electrode layer can have a conductive carbon material of about 0.1-6 wt. %, about 0.5-3 wt. %, or about 1.5-2.5 wt. % of the electrode layer. In some embodiments, an electrode layer loading on the lithium coated current collector can be about 5-30 mg/cm², about 10-25 mg/cm², about 12-22 mg/cm², or about 15-20 mg/cm².

After the lithium coated current collector is coated with the at least one electrode layer, the electrode-lithium coated current collector can be calendered. In some embodiments, calender 206 can be configured to receive the electrode-lithium coated current collector and apply pressure to the electrode-lithium coated current collector. In some embodiments, the calender can be carbon steel and/or include hard rollers. In some embodiments, the electrode-lithium coated current collector can be calendered to the desired porosity (e.g., about 10-50%, about 20-40%, about 25-35%, or about 30%). In some embodiments, calendering the electrode-lithium coated current collector bonds the electrode layer(s) to the lithium coated current collector.

Calendering can provide the pressure to facilitate pre-lithiation of the at least one electrode layer. In some embodiments, calendering the electrode-lithium current collector can transfer lithium from the lithium coated current collector to the electrode layer to form the pre-lithiated electrode film 207. In some embodiments, calendering the electrode-lithium coated current collector densifies the electrode-lithium coated current collector when it forms the pre-lithiated electrode film. In some embodiments, press densities (after calendering) of the pre-lithiated electrode film can be from about 0.5-5 g/cm³, about 1-4 g/cm³, about 1-3 g/cm³, about 1-2 g/cm³, or about 1.5-1.7 g/cm³.

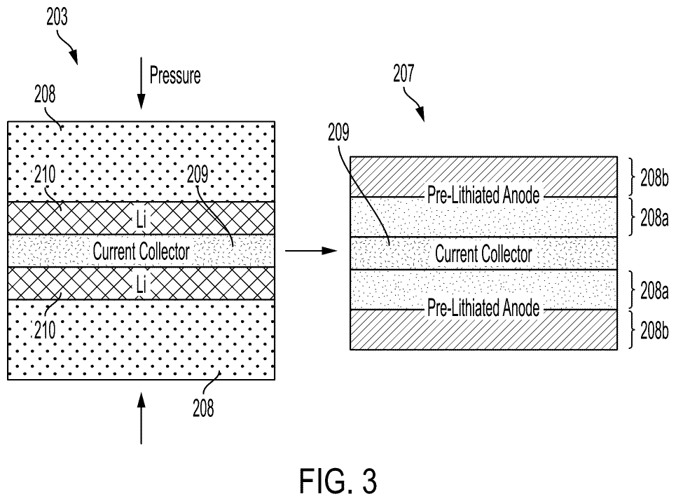

In some embodiments, the pre-lithiated electrode film can have the same structure as the electrode-lithium coated current collector described above. As stated above, calendering the electrode-lithium coated current collector can transfer lithium from the lithium layer(s) of the lithium coated current collector to the electrode layer(s). As shown in FIG. 3, current collector 209 with lithium layers 210 on each side of the current collector and electrode layers 208 on the external side of lithium layers 120 can be calendered. The pressure applied by the calender can result in pre-lithiated electrode 207 that has an increased concentration of lithium towards the internal current collector surfaces. FIG. 3 also illustrates a hypothetical pre-lithiated electrode 207 having electrode layers 208 on each side of the current collector 209, wherein a first portion 208a of the electrode layer closer to the current collector has a greater concentration of lithium than a second portion 208b of the electrode layer farther from the current collector. In some embodiments, the pre-lithiated electrode may still have a lithium layer on at least one side of the current collector, but some of the lithium may have entered the electrode layer(s).

Unlike FIG. 1, the lithium layer can be adjacent to the interface between the current collector and the electrode layer, which can favorably modify the lithium concentration as shown in FIG. 3. The accumulation of lithium in proximity to the current collector may enable a favorable solid electrolyte interphase in comparison to that of FIG. 1 with lithium deposited on top of the electrode surface.

There may be additional advantage to electrode processing utilizing the methods and systems disclosed herein in addition to pre-lithiation. For example, alkali metals, specifically lithium, are soft and known to have a sticky surface when solid. In a lithium metal anode, this can lead to eventual dendritic growth and hence cell failure. However, in the methods and systems disclosed herein, the lithium layer on a side of the current collector can offer a top (and/or bottom) layer analogous to an adhesive tape for the electrode. The subsequent pre-lithiation can enable an electrode that is chemically bound to the current collector. In addition, the processing of a direct contact pre-lithiation can be simplified by removing the deposition of lithium on a sacrificial substrate which requires management and delamination after the calendering process such as that substrate layer shown in FIG. 1. In contrast, the systems and methods disclosed herein can calender the entire electrode film (e.g., current collector, lithium layer(s), electrode layer(s)) as a single entity, thereby simplifying downstream processing of the pre-lithiated electrode.

In some embodiments, the pre-lithiated electrode can be wound into a roll (via rewinder 210) for later use. In some embodiments, the pre-lithiated electrode can be sent to a notcher configured to receive the pre-lithiated electrode film and cut (or slit) the pre-lithiated electrode film into a plurality of electrodes. These electrodes can then be assembled into a battery cell.

### Battery Cells, Battery Modules, Battery Packs, and Electric Vehicle Systems

After the pre-lithiated electrode or pre-lithitated electrode film has been created, it can be inserted into a battery cell which can be used as an electrical energy source. For example, the pre-lithiated electrodes or pre-lithiated electrode films disclosed herein can be an electrode layer (e.g., an anode layer) used in a battery cell.

Reference will now be made to implementations and embodiments of various aspects and variations of battery cells, battery modules, battery packs, and the methods of making such battery cells, battery modules, and battery packs. Although several exemplary variations of the battery cells, modules, packs, and methods of making them are described herein, other variations of the battery cells, modules, packs and methods may include aspects of the battery cells, modules, packs and methods described herein combined in any suitable manner having combinations of all or some of the aspects described. In addition, any part of or any of the pre-lithiated electrodes, components, systems, methods, apparatuses, devices, compositions, etc. described herein can be implemented into the battery cells, battery modules, battery packs, and methods of making these battery cells, battery modules, and battery packs.

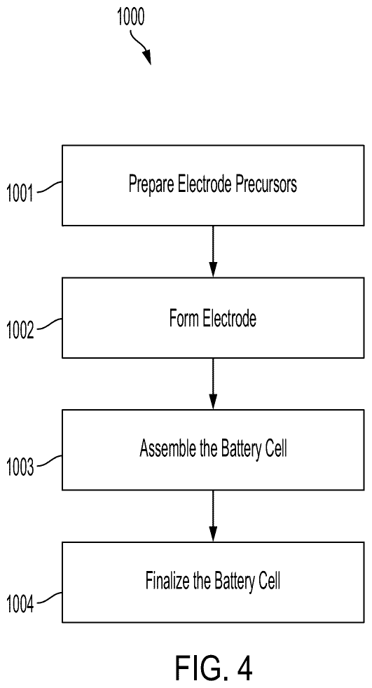

FIG. 4 illustrates a flow chart for a typical battery cell manufacturing process 1000. These steps are not exhaustive and other battery cell manufacturing processes can include additional steps or only a subset of these steps. At step 1001, the electrode precursors (e.g., binder, active material, conductive carbon additive) can be prepared. In some embodiments, this step can include mixing electrode materials (e.g., active materials) with additional components (e.g., binders, solvents, conductive additives, etc.) to form an electrode slurry. In some embodiment, this step can include synthesizing the electrode materials themselves.

At step 1002, the electrode can be formed. In some embodiments, this step can include coating an electrode slurry on a current collector. After coating, the coated current collector can be dried to evaporate any solvent. In some embodiments, this step can include calendaring the coated current collectors. Calendaring can adjust the physical properties (e.g., bonding, conductivity, density, porosity, etc.) of the electrodes. In some embodiments, the electrode can then be sized via a slitting and/or notching machine to cut the electrode into the proper size and/or shape.

In solid state cells, prelithiation may be desirable if there is a species that can result in lithium loss. In some embodiments, solid electrolyte materials of the solid electrolyte layer can include inorganic solid electrolyte materials such as oxides, sulfides, phosphides, halides, ceramics, solid polymer electrolyte materials, hybrid solid state electrolytes, or glassy electrolyte materials, among others, or in any combinations thereof. In some embodiments, the solid electrolyte layer can include a polyanionic or oxide-based electrolyte material (e.g., Lithium Superionic Conductors (LISICONs), Sodium Superionic Conductors (NASICONs), perovskites with formula ABO₃ (A=Li, Ca, Sr, La, and B=Al, Ti), garnet-type with formula A₃B₂(XO₄)₃ (A=Ca, Sr, Ba and X=Nb, Ta), lithium phosphorous oxy-nitride (LixPOyNz), among others, or in any combinations thereof. In some embodiments, the solid electrolyte layer can include a glassy, ceramic and/or crystalline electrolyte material such as Li₃PS₄, Li₇P₃S₁₁, Li₂S—P₂S₅, Li₂S—B₂S₃, SnS—P₂S₅, Li₂S—SiS₂, Li₂S—P₂S₅, Li₂S—GeS₂, lithium phosphorous oxy-nitride (LiₓPO_{y}N_{z}), lithium germanium phosphate sulfur (Li₁₀GeP₂S₁₂), Yttria-stabilized Zirconia (YSZ), NASICON (Na₃Zr₂Si₂PO₁₂), beta-alumina solid electrolyte (BASE), perovskite ceramics (e.g., strontium titanate (SrTiO₃)), Lithium lanthanum zirconium oxide (La₃Li₇O₁₂Zr₂), Li SiCON (Li2+2xZn1−xGeO4), lithium lanthanum titanate (Li₃xLa2/3-xTiO3) and/or sulfide-based lithium argyrodites with formula Li₆PS₅X (X=Cl, Br) like Li₆PS₅Cl, among others, or in any combinations thereof. Furthermore, solid state polymer electrolyte materials can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), and PEG, among others, or in any combinations thereof.

At step 1003, the battery cell can be assembled. After the electrodes, separators, and/or electrolytes have been prepared, a battery cell can be assembled/prepared. In this step, the separator and/or an electrolyte layer can be layered between the anode and cathode layers to form the internal structure of a battery cell. These layers can be layered by a winding method such as a round winding or prismatic/flat winding, a stacking method, or a z-folding method. The assembled cell structure can then be inserted into a cell housing which is then partially or completely sealed. In addition, the assembled structure can be connected to terminals and/or cell tabs (via a welding process). For battery cells utilizing a liquid electrolyte, the housed cell with the electrode structure inside it can also be filled with electrolyte and subsequently sealed.

Battery cells can have a variety of form factors, shapes, or sizes. For example, battery cells (and their housings/casings) can have a cylindrical, rectangular, square, cubic, flat, or prismatic form factor, among others. There are four main types of battery cells: (1) button or coin cells; (2) cylindrical cells; (3) prismatic cells; and (4) pouch cells. Battery cells can be assembled, for example, by inserting a winding and/or stacked electrode roll (e.g., a jellyroll) into a battery cell casing or housing. In some embodiments, the winded or stacked electrode roll can include the electrolyte material. In some embodiments, the electrolyte material can be inserted in the battery casing or housing separate from the electrode roll. In some embodiments, the electrolyte material includes, but is not limited to, an ionically conductive fluid or other material (e.g., a layer) that can allow the flow of electrical charge (i.e., ion transportation) between the cathode and anode. In some embodiments, the electrolyte material can include a non-aqueous polar solvent (e.g., a carbonate such as ethylene carbonate, propylene carbonate, diethyl carbonate, ethyl methyl carbonate, dimethyl carbonate, or a mixture of any two or more thereof). The electrolytes may also include other additives such as, but not limited to, vinylidene carbonate, fluoroethylene carbonate, ethyl propionate, methyl propionate, methyl acetate, ethyl acetate, or a mixture of any two or more thereof. The lithium salt of the electrolyte may be any of those used in lithium battery construction including, but not limited to, lithium perchlorate, lithium hexafluorophosphate, lithium bis(fluorosulfonyl)imide, lithium bis(trifluorosulfonyl)imide, or a mixture of any two or more thereof. In addition, the salt may be present in the electrolyte from greater than 0 M to about 5 M or, for example, salt may be present between about 0.05 to 2 M or about 0.1 to 2 M.

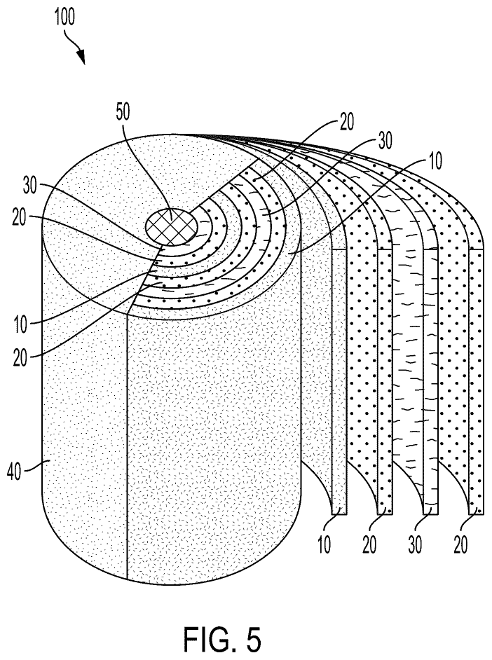

FIG. 5 depicts an illustrative example of a cross sectional view of a cylindrical battery cell 100. The cylindrical battery cell can include layers (e.g., sheet-like layers) of anode layers 10, separator and/or electrolyte layers 20, and cathode layers 30.

A battery cell can include at least one anode layer, which can be disposed within the cavity of the housing/casing. The battery cell can also include at least one cathode layer. The at least one cathode layer can also be disposed within the housing/casing. In some embodiments, when the battery cell is discharging (i.e., providing electric current), the at least one anode layer releases ions (e.g., lithium ions) to the at least one cathode layer generating a flow of electrons from one side to the other. Conversely, in some embodiments, when the battery cell is charging, the at least one cathode layer can release ions and the at least one anode layer can receive these ions.

These layers (cathode, anode, separator/electrolyte layers) can be sandwiched, rolled up, and/or packed into a cavity of a cylinder-shaped casing 40 (e.g., a metal can). The casings/housings can be rigid such as those made from metallic or hard-plastic, for example. In some embodiments, a separator layer (and/or electrolyte layer) 20 can be arranged between an anode layer 10 and a cathode layer 30 to separate the anode layer 20 and the cathode layer 30. In some embodiments, the layers in the battery cell can alternate such that a separator layer (and/or electrolyte layer) separates an anode layer from a cathode layer. In other words, the layers of the battery electrode can be (in order) separator layer, anode/cathode layer, separator layer, opposite of other anode/cathode layer and so on. The separator layer (and/or electrolyte layer) 20 can prevent contact between the anode and cathode layers while facilitating ion (e.g., lithium ions) transport in the cell. The battery cell can also include at least one terminal 50. The at least one terminal can be electrical contacts used to connect a load or charger to a battery cell. For example, the terminal can be made of an electrically conductive material to carry electrical current from the battery cell to an electrical load, such as a component or system of an electric vehicle as discussed further herein.

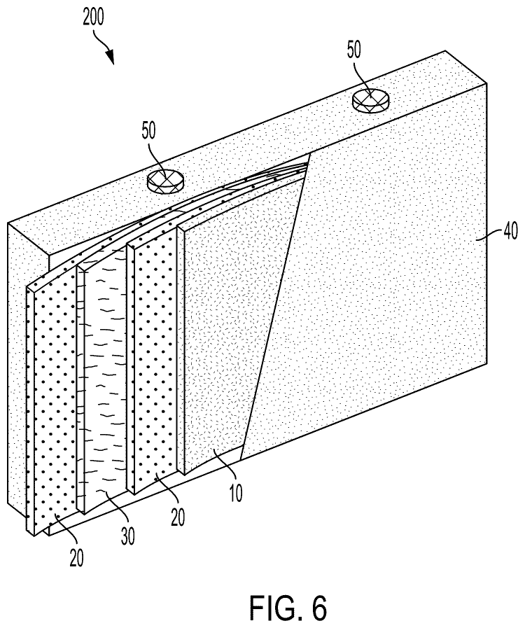

FIG. 6 depicts an illustrative example of a cross sectional view of a prismatic battery cell 200. The prismatic battery cell can include layers (e.g., sheet-like layers) of anode layers 10, separator and/or electrolyte layers 20, and cathode layers 30. Similar to the cylindrical battery cell, the layers of a prismatic battery cell can be sandwiched, rolled, and/or pressed to fit into cubic or rectangular cuboid (e.g., hyperrectangle) shaped casing/housing 40. In some embodiments, the layers can be assembled by layer stacking rather than jelly rolling. In some embodiments, the casing or housing can be rigid such as those made from a metal and/or hard-plastic. In some embodiments, the prismatic battery cell 200 can include more than one terminal 50. In some embodiments, one of these terminals can be the positive terminal and the other a negative terminal. These terminals can be used to connect a load or charger to the battery cell.

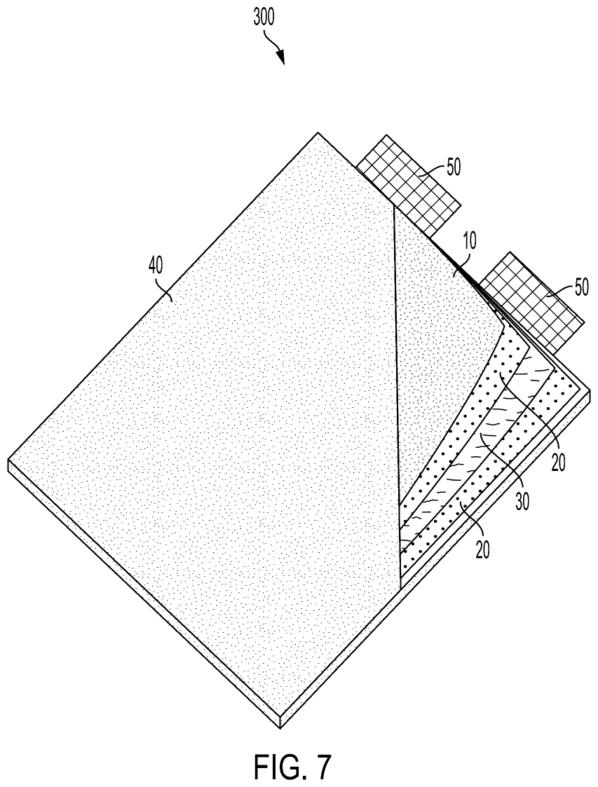

FIG. 7 depicts an illustrative example of a cross section view of a pouch battery cell 300. The pouch battery cells do not have a rigid enclosure and instead use a flexible material for the casing/housing 40. This flexible material can be, for example, a sealed flexible foil. The pouch battery cell can include layers (e.g., sheet-like layers) of anode layers 10, separator and/or electrolyte layers 20, and cathode layers 30. In some embodiments, these layers are stacked in the casing/housing. In some embodiments, the pouch battery cell 200 can include more than one terminal 50. In some embodiments, one of these terminals can be the positive terminal and the other the negative terminal. These terminals can be used to connect a load or charger to the battery cell.

The casings/housings of battery cells can include one or more materials with various electrical conductivity or thermal conductivity, or a combination thereof. In some embodiments, the electrically conductive and thermally conductive material for the casing/housing of the battery cell can include a metallic material, such as aluminum, an aluminum alloy with copper, silicon, tin, magnesium, manganese, or zinc (e.g., aluminum 1000, 4000, or 5000 series), iron, an iron-carbon alloy (e.g., steel), silver, nickel, copper, and a copper alloy, among others. In some embodiments, the electrically conductive and thermally conductive material for the housing of the battery cell can include a ceramic material (e.g., silicon nitride, silicon carbide, titanium carbide, zirconium dioxide, beryllium oxide, and among others) and/or a thermoplastic material (e.g., polyethylene, polypropylene, polystyrene, polyvinyl chloride, or nylon), among others.

At step 1004, the battery cell can be finalized. In some embodiments, this step includes the formation process wherein the first charging and discharging process for the battery cell takes place. In some embodiments, this initial charge and discharge can form a solid electrolyte interface between the electrolyte and the electrodes. In some embodiments, this step may cause some of the cells to produce gas which can be removed in a degassing process from the battery cell. In some embodiments, this step includes aging the battery cell. Aging can include monitoring cell characteristics and performance over a fixed period of time. In some embodiments, this step can also include testing the cells in an end-of-line (EOL) test rig. The EOL testing can include discharging the battery cells to the shipping state of charge, pulse testing, testing internal resistance measurements, testing OCV, testing for leakage, and/or optically inspecting the battery cells for deficiencies.

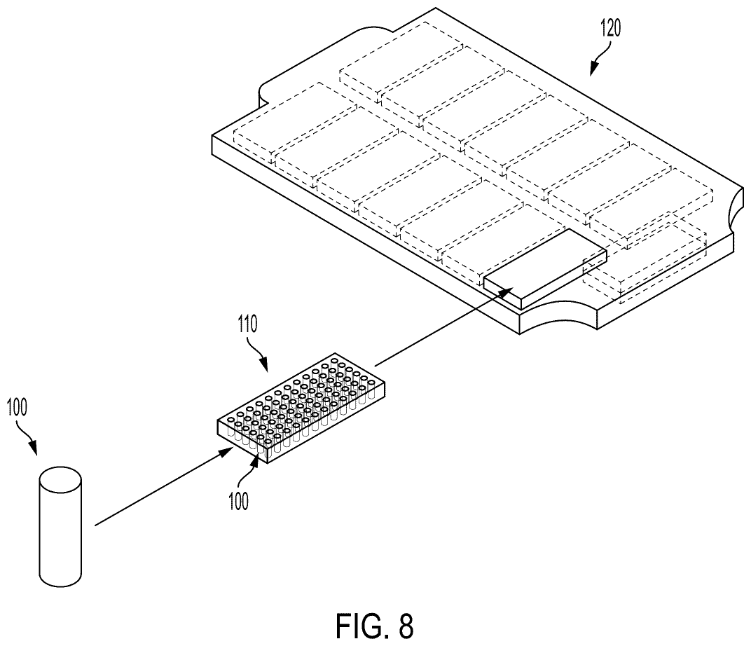

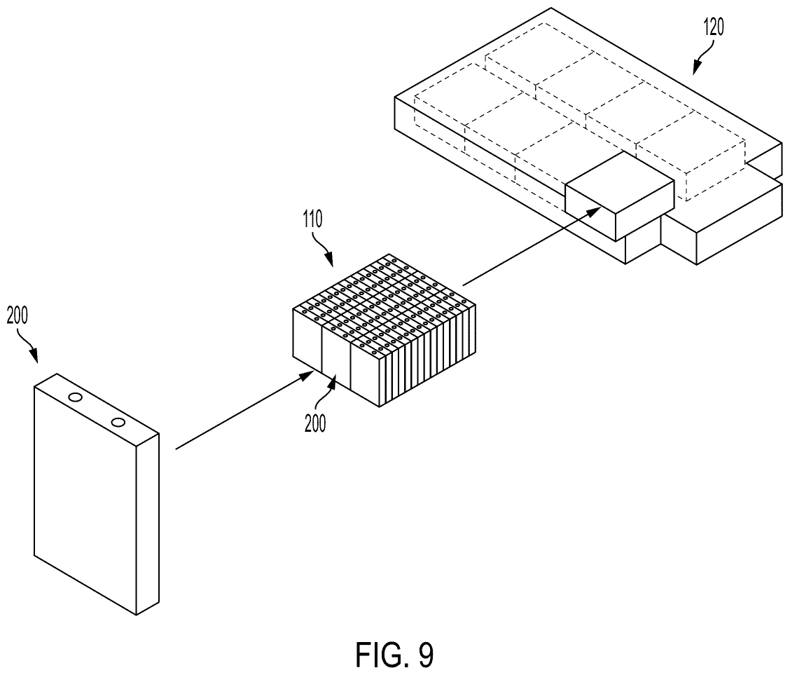

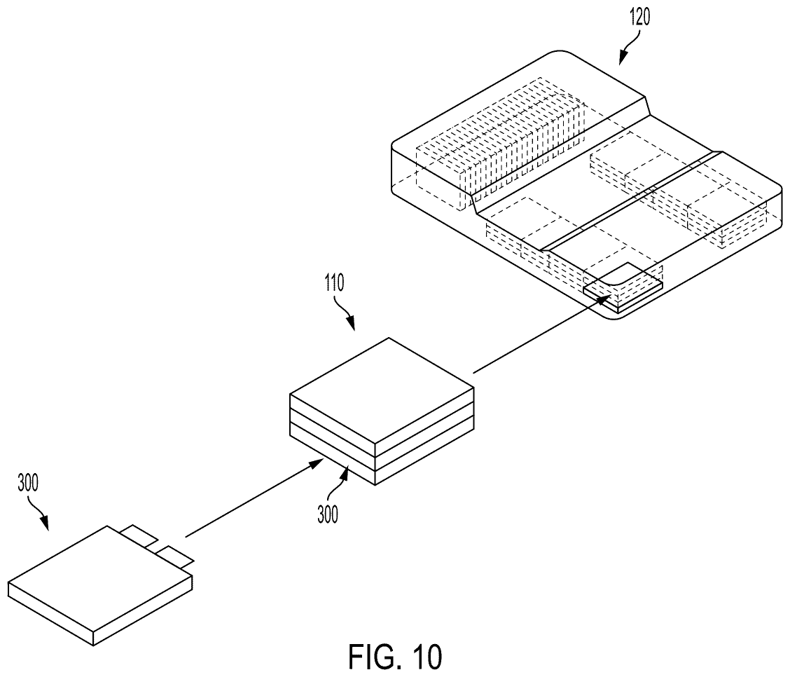

A plurality of battery cells (100, 200, and/or 300) can be assembled or packaged together in the same housing, frame, or casing to form a battery module. The battery cells of a battery module can be electrically connected to generate an amount of electrical energy. These multiple battery cells can be linked to the outside of the housing, frame, or casing, through a uniform boundary. The battery cells of the battery module can be in parallel, series, or a series-parallel combination of battery cells. The housing, frame, or casing can protect the battery cells from a variety of dangers (e.g., external elements, heat, vibration, etc.). FIG. 8 illustrates cylindrical battery cells 100 being inserted into a frame to form battery module 110. FIG. 9 illustrates prismatic battery cells 200 being inserted into a frame to form battery module 110. FIG. 10 illustrates pouch battery cells 300 being inserted into a frame to form battery module 110.

A plurality of the battery modules 110 can be disposed within another housing, frame, or casing to form a battery pack 120 as shown in FIGS. 8-10. In some embodiments, a plurality of battery cells can be assembled, packed, disposed within a housing, frame, or casing to form a battery pack (not shown). In such embodiments, the battery pack may not include a battery module (e.g., module-free). For example, the battery pack can have a cell-to-pack configuration where the battery cells can be arranged directly into a battery pack without assembly into a battery module. In some embodiments, the battery cells of the battery pack can be electrically connected to generate an amount of electrical energy to be provided to another system (e.g., an electric vehicle).

The battery modules of a battery pack can be electrically connected to generate an amount of electrical energy to be provided to another system (e.g., an electric vehicle). The battery pack can also include various control and/or protection systems such as a heat exchanger system (e.g., a cooling system) configured to regulate the temperature of the battery pack (and the individual modules and battery cells) and a battery management system configured to control the battery pack's voltage, for example. In some embodiments, a battery pack housing, frame, or casing can include a shield on the bottom or underneath the battery modules to protect the battery modules from external elements. In some embodiments, a battery pack can include at least one heat exchanger (e.g., a cooling line configured to distribute fluid through the battery pack or a cold plate as part of a thermal/temperature control or heat exchange).

In some embodiments, battery modules can collect current or electrical power from the individual battery cells that make up the battery modules and can provide the current or electrical power as output from the battery pack. The battery modules can include any number of battery cells and the battery pack can include any number of battery modules. For example, the battery pack can have one, two, three, four, five, six, seven, eight, nine, ten, eleven, twelve or other number of battery modules disposed in the housing/frame/casing. In some embodiments, a battery module can include multiple submodules. In some embodiments, these submodules may be separated by a heat exchanger configured to regulate or control the temperature of the individual battery module. For example, a battery module can include a top battery submodule and a bottom battery submodule. These submodules can be separated by a heat exchanger such as a cold plate in between the top and bottom battery submodules.

The battery packs can come in all shapes and sizes. For example, FIGS. 8-10 illustrates three differently shaped battery packs 120. As shown in FIGS. 8-10, the battery packs 120 can include or define a plurality of areas, slots, holders, containers, etc. for positioning of the battery modules. The battery modules can come in all shapes and sizes. For example, the battery modules can be square, rectangular, circular, triangular, symmetrical, or asymmetrical. In some examples, battery modules in a single battery pack may be shaped differently. Similarly, the battery module can include or define a plurality of areas, slots, holders, containers, etc. for the plurality of battery cells.

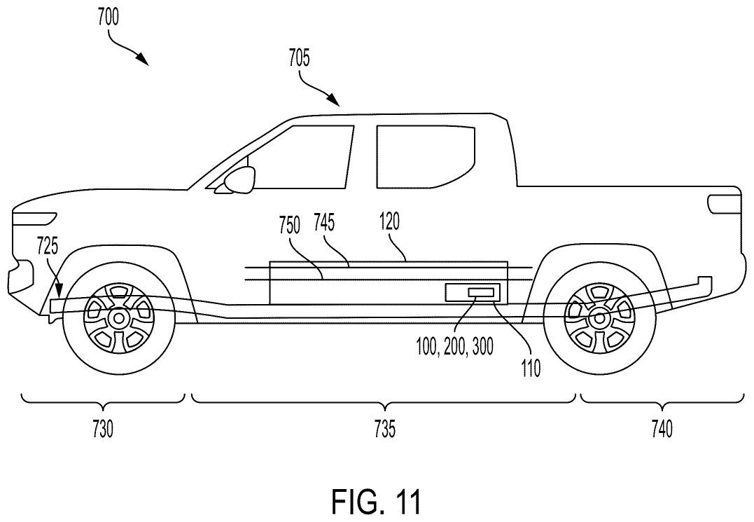

FIG. 11 illustrates an example of a cross sectional view 700 of an electric vehicle 705 that includes at least one battery pack 120. Electric vehicles can include, but are not limited to, electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. Electric vehicles can be fully electric or partially electric (e.g., plug-in hybrid) and further, electric vehicles can be fully autonomous, partially autonomous, or unmanned. In addition, electric vehicles can also be human operated or non-autonomous.

Electric vehicles 705 can be installed with a battery pack 120 that includes battery modules 110 with battery cells (100, 200, and/or 300) to power the electric vehicles. The electric vehicle 705 can include a chassis 725 (e.g., a frame, internal frame, or support structure). The chassis 725 can support various components of the electric vehicle 705. In some embodiments, the chassis 725 can span a front portion 730 (e.g., a hood or bonnet portion), a body portion 735, and a rear portion 740 (e.g., a trunk, payload, or boot portion) of the electric vehicle 705. The battery pack 120 can be installed or placed within the electric vehicle 705. For example, the battery pack 120 can be installed on the chassis 725 of the electric vehicle 705 within one or more of the front portion 730, the body portion 735, or the rear portion 740. In some embodiments, the battery pack 120 can include or connect with at least one busbar, e.g., a current collector element. For example, the first busbar 745 and the second busbar 750 can include electrically conductive material to connect or otherwise electrically couple the battery pack 120 (and/or battery modules 110 or the battery cells 100, 200, and/or 300) with other electrical components of the electric vehicle 705 to provide electrical power to various systems or components of the electric vehicle 705. In some embodiments, battery pack 120 can also be used as an energy storage system to power a building, such as a residential home or commercial building instead of or in addition to an electric vehicle.

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

Reference to “about” a value or parameter herein includes (and describes) variations that are directed to that value or parameter per se. For example, description referring to “about X” includes description of “X”. In addition, reference to phrases “less than”, “greater than”, “at most”, “at least”, “less than or equal to”, “greater than or equal to”, or other similar phrases followed by a string of values or parameters is meant to apply the phrase to each value or parameter in the string of values or parameters.

This application discloses several numerical ranges in the text and figures. The numerical ranges disclosed inherently support any range or value within the disclosed numerical ranges, including the endpoints, even though a precise range limitation is not stated verbatim in the specification because this disclosure can be practiced throughout the disclosed numerical ranges.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. A method of forming a pre-lithiated electrode film comprising:
depositing an electrode layer on a lithium coated current collector to form an electrode-lithium coated current collector; and
calendering the electrode-lithium coated current collector to transfer lithium from the lithium coated current collector to the electrode layer to form the pre-lithiated electrode film.

2. The method of claim 1, wherein a first concentration of lithium in a first portion of the electrode layer closer to the current collector is greater than a second concentration of lithium in a second portion of the electrode layer that is farther from the current collector.

3. The method of claim 1, further comprising cutting the pre-lithiated electrode film into a plurality of pre-lithiated electrodes.

4. The method of claim 1, further comprising depositing a layer comprising lithium on a current collector to form the lithium coated current collector.

5. The method of claim 4, wherein the layer comprising lithium is deposited via thermal evaporation, e-beam evaporation, or sputtering.

6. The method of claim 4, further comprising depositing a protection layer on a surface of the layer comprising lithium opposite the current collector, wherein the protection layer passivates the surface of the layer comprising lithium.

7. The method of claim 6, wherein the protection layer comprises lithium oxide, lithium nitride, lithium hydroxide, lithium carbonate, or a combination thereof.

8. The method of claim 1, further comprising unwinding a roll of a lithium coated current collector film, wherein the lithium coated current collector film comprises the lithium coated current collector and a substrate layer on a side of the lithium coated current collector.

9. The method of claim 8, further comprising separating the substrate layer from the lithium coated current collector prior to depositing the electrode layer on the lithium coated current collector.

10. The method of claim 9, further comprising rewinding the separated substrate layer into a roll.

11. The method of claim 1, wherein calendering the electrode-lithium coated current collector increases a density of electrode-lithium coated current collector.

12. The method of claim 1, wherein calendering the electrode-lithium coated current collector bonds the electrode layer to the lithium coated current collector.

13. An electrode comprising:
a current collector;
an electrode layer on a side of the current collector, wherein a first portion of the electrode layer closer to the current collector has a greater concentration of lithium than a second portion of the electrode layer farther from the current collector.

14. The electrode of claim 13, wherein the current collector comprises a copper or nickel foil.

15. The electrode of claim 13, wherein the electrode layer is an anode layer.

16. The electrode of claim 13, further comprising a second electrode layer on a side of the current collector opposite the first electrode layer, wherein a first portion of the second electrode layer closer to the current collector has a greater concentration of lithium than a second portion of the second electrode layer farther from the current collector.

17. A battery cell comprising the electrode of claim 13.

18. A vehicle system comprising the battery cell of claim 17.

19. A system comprising:
an electrode coater configured to receive a lithium coated current collector and to deposit an electrode layer on the lithium coated current collector to form an electrode-lithium coated current collector; and
a calender configured to receive the electrode-lithium coated current collector and apply pressure to the electrode-lithium coated current collector to transfer lithium from the lithium coated current collector to the electrode layer to form a pre-lithiated electrode film.

20. The system of claim 19, wherein a first concentration of lithium in a first portion of the electrode layer closer to the current collector is greater than a second concentration of lithium in a second portion of the electrode layer that is farther from the current collector.
